(19) United States
(12) Patent Application Publication
(10) Pub. No.: US 2007/0067830 A1
(43) Pub. Date: Mar. 22, 2007

(54) System and method for network device administration

(75) Inventors: Min Kuo, Temple City, CA (US); Vincent Wu, Irvine, CA (US); Brenda Daos, Mission Viejo, CA (US); Harpreet Singh, Orange, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignee: Kabushiki Kaisha Toshiba and Toshiba Tec Kabushiki Kaisha, Tokyo (JP)

(21) Appl. No.: 11/231,068

(22) Filed: Sep. 20, 2005

(51) Int. Cl. H04L 9/32

(52) U.S. Cl. 726/5

(57) ABSTRACT

A system and method for network device administration. The system includes a file generator, which generates an encrypted file containing data representing multiple usernames and a corresponding number of passwords. The encrypted file is then transmitted to each networked data device on the network. Connection data is then received representing an acceptance via a workstation of an entry of a username and password relative to data in the encrypted electronic file. A selected, shared networked device is then selectively enabled upon receipt of the connection data.

### BACKGROUND OF THE INVENTION

This invention is directed to a system and method for the administration of network devices. More particularly, this invention is directed to a system and method for the secure transmission authentication data via a computer network.

Typical secure networks require multiple prompts to a user, requiring the user to repeatedly enter a username and corresponding password. The repeated entry of the username/password leads to vulnerability in the integrity of the network. For example, during any one of the prompts at which the user inputs his username/password, the username and/or password may be stolen by another user viewing the input of the username/password. Another problem resulting from the numerous prompts occurs when the user mistypes either the username or password. The use of an incorrect username or password typically expels the user from whatever level of security he has already attained, thereby requiring him to start from the beginning to log into the secure network.

Due to the nature of the username and password combination, users frequently write down or otherwise store the username/password. The written identification/Password constitutes a serious breach of the computer network, as the paper it is written on may be easily lost or stolen. Additional problems exist in maintaining a secure wide area network, as the distribution of users prevents an administrator from personally delivering new usernames and passwords. Thus, electronic communication of IDs and passwords, via email and the like, are used to transmit new logon information to users. Absent extremely secure communications systems, such transmissions are easily intercepted. Furthermore, administrators of computer networks frequently must deal with the constant changing of users and devices on the network, such as the addition of new users and/or devices, and the removal of other users and/or devices. Each change requires adjustments to the usernames and passwords accepted on the network by shared devices, which must then be shared with the new and existing users and devices, thereby maintaining the security of the network itself.

Thus there is a need for a system and method for the secure transmission of authentication data via a computer network.

### SUMMARY OF THE INVENTION

In accordance with the present invention, there is provided a network device administration system and method.

Further, in accordance with the present invention, there is provided a system and method for the secure transmission of authentication data via a computer network.

Still further, in accordance with the present invention, there is provided a system and method for securely transmitting password and usernames in an encrypted format to a client machine over a computer network.

Still further, in accordance with the present invention, there is provided a network device administration system. The system includes a file generator, which generates an encrypted file containing data representing multiple usernames and a corresponding number of passwords. Transmission means are then employed to transmit the encrypted file to each networked data device on the network. The system further includes receiving means adapted to receive connection data representing an acceptance via a workstation of an entry of a username and password relative to data in the encrypted electronic file. The system further includes enablement means suitably adapted to selectively enable a selected shared networked data device upon receipt of the connection data.

Still further, in accordance with the present invention, there is provided a method for network device administration. The method begins by generating an encrypted electronic data file containing data representing a plurality of usernames and a corresponding plurality of passwords. The encrypted electronic file is then communicated to each of a plurality of networked data devices. Connection data is then received representing acceptance via a workstation of an entry of a username and password relative to data in the encrypted electronic file. A selected, shared networked device is then selectively enabled upon receipt of the connection data.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description, serve to explain the principles of the invention.

FIG. 1 is a block diagram illustrating a system in accordance with the present invention;

FIG. 2 is a flow chart illustrating a method in accordance with the present invention;

FIG. 3 is an administrative add a user template screen in accordance with the present invention;

FIG. 4 is an administrative import/export/create template screen in accordance with the present invention;

FIG. 5 is a flow chart illustrating a method in accordance with the present invention; and

FIG. 6 is a username selection template screen in accordance with the present invention.

### DETAILED DESCRIPTION OF THE PREFERRED EMBODIMENT

The present invention is directed to a system and method for network device administration. More particularly, the present invention is directed to a system and method for securely transmitting authentication information, such as a username and password, in an encrypted format over a computer network.

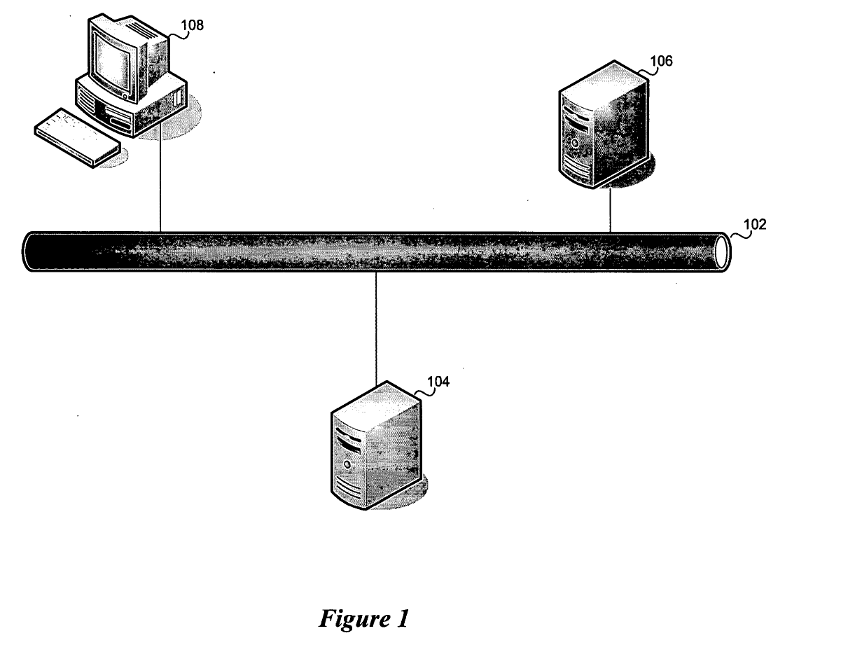

Turning now to FIG. 1, there is shown a diagram illustrating a system 100 in accordance with the present invention. As shown in FIG. 1, the system 100 includes a computer network 102 capable of carrying data communications between a plurality of electronic devices. As will be appreciated by those skilled in the art, the computer network is any type of computer network known in the art, including the Internet, local area network, wide area network, and the like. More preferably, the computer network 102 is suitably adapted to employ secure network communications protocols, such as for example and without limitation, a simple network management protocol versions 1-3 (SNMPv1, SNMPv2, SNMPv3). As will be understood by those skilled in the art, other security-based protocols are equally capable of being implemented in accordance with the present invention, without departing from the scope thereof. The plurality of electronic devices are suitably able to receive and transmit data over the network 102 using any communications link known in the art. As will be understood by those skilled in the art, the communications link is any means for communication between electronic devices, including for example and without limitation, an Ethernet based network, infrared connection, Wi-Fi connection, telephone connection, cellular connection, Bluetooth connection and the like or any combination of communication means thereof.

The system 100 of FIG. 1 also includes an administrator, illustrated as the administrative device 104, in data communication with the computer network 102. As will be understood by those skilled in the art, the administrative device 104 is able to communicate with each of the devices communicatively coupled to the computer network 102. Preferably, the administrative device 104 is connected to the network 102 using a suitable communications channel, such as, for example and without limitation, an infrared connection, telephone connection, Ethernet based connection, Wi-Fi connection, cellular connection, Bluetooth connection and the like or any combination of communication means thereof. The skilled artisan will appreciate that the administrative device 104 is representative of a device suitably employed by the system administrator to facilitate the management of usernames, passwords, and usage rights in accordance with the present invention. Those skilled in the art will appreciate that other devices are equally capable of being employed to manage the users on the network 102 and provide access to the devices communicatively coupled to the computer network 102, without departing from the scope of the present invention.

In accordance with the present invention, the administrative device 104 is suitably adapted to generate an encrypted file containing a username and password. As will be understood by those skilled in the art, any suitable means of encrypting the data contained in the file known in the art are capable of being implemented by the present invention. Preferably, each file includes a username, a corresponding password, and any associated privileges, for example and without limitation, read only, read/write, and the like. As set forth in greater detail below, only the administrator is able to decrypt and alter the file contents. Further in accordance with the present invention, as explained below, the encrypted file containing the username, password, and associated privileges, is sent to the user for installation on the user's client machine. It will be appreciated by those skilled in the art that the file provides the server 106 with the username and password needed to authenticate the client machine, as well as informing the server 106 with he privileges, rights and permissions associated with that particular username/password combination.

In accordance with one aspect of the present invention, the administrative device 104 is suitably adapted to transmit, via the computer network 102, an encrypted file containing a username and password for a server 106 to a client device 108. It will be understood by those skilled in the art that in one embodiment of the present invention, the server 106 suitably requires authentication data to be transmitted from the client device 108. It will further be appreciated by those skilled in the art that in addition to authentication data, the server 106 is also capable of receiving associated user rights and privileges corresponding to the username and password submitted from the client device 108.

As shown in FIG. 1, the server 106 is any shared electronic device communicatively coupled to the computer network 102 and capable of providing one or more services to various users on the network 102. In one embodiment, the shared electronic device is a server containing storage media accessible via the secure computer network. In another embodiment, the shared electronic device is an application server through which various devices on the secure network 102 gain access to a plurality of programs. In still another embodiment, the server 106 is a document processing device, such as a multifunction peripheral device, used by to generate or process image data. Those skilled in the art will appreciate that the document processing device is any suitable document processing device known in the art, such as a copier, printer, scanner, facsimile and the like, or any combination thereof. Suitable commercially available document processing peripherals include, but are not limited to, the Toshiba e-Studio Series Controller.

In the preferred embodiment, the server 106 is suitably connected to the computer network 102 via any suitable means known in the art. The server 106 is suitably adapted to receive and transmit data over the network 102 using any communications link known in the art. As will be understood by those skilled in the art, the communications link is any means for communication between electronic devices, including for example and without limitation, an Ethernet based network, infrared connection, Wi-Fi connection, telephone connection, cellular connection, Bluetooth connection and the like or any combination of communication means thereof.

In addition to administrative device 104, the client device 108 is also in data communication with the computer network 102 via any suitable communications means known in the art. As will be understood by those skilled in the art, the client device 108 is representative of any personal electronic user device used to access the server 106, including, without limitation, a personal data assistant, web-enabled cellular telephone, laptop computer, Apple computer, and the like. The client device 108 is further capable of communicating with the administrative device 104, via the computer network 102. It will be appreciated by those skilled in the art that the client device 108 suitably receives administrative data from the administrative device 104. Such administrative data includes, but is not limited to, suitable username and password, network rights and privileges, network address assignments, and other administrative data known in the art.

Thus, the server 106 suitably includes username and password sets to verify the authenticity of the user of the client device 108 and the corresponding read/write/print/fax/scan/copy/storage rights associated therewith. It will be understood by those skilled in the art that each change made to such server 106 username and password sets requires the administrative device 104 to send out information exposing server 106 confidential information to all end users, e.g., the client device 108. Confidential information is capable of including, but is not limited to, network addresses, device capabilities, account information, and the like. In one embodiment, the server 106 enables SNMPv3 and requires that any connecting device 108 be authenticated before the server 106 sends SNMP information to the connecting device 108. In accordance with the present invention, the administrative device 104 provides the connecting device 108 the name of a file containing encrypted usernames and passwords. Preferably, the user of the connecting device 108 is prompted to enter the filename when initially installing and configuring the device drivers or utilities on the connecting device 108. As will be appreciated by the skilled artisan, authentication results in the user's ability to receive secure information, e.g., SNMP information, from the specific secure device, e.g., the SNMPv3 enabled network device.

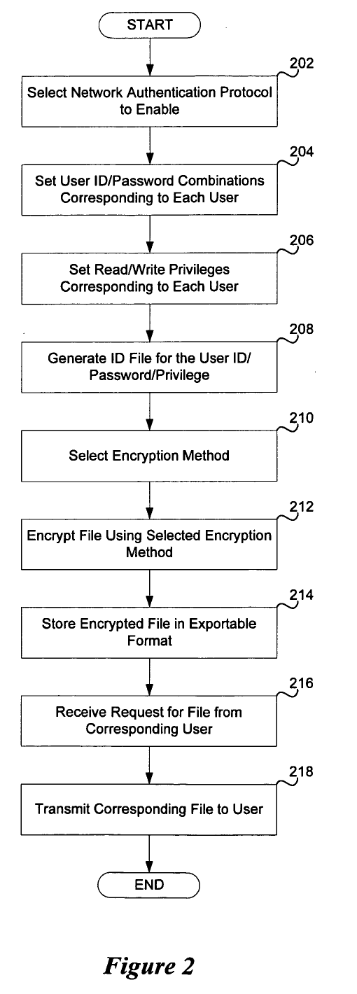

Turning now to FIG. 2, there is shown a flow chart 200 illustrating an administrative method wherein an encrypted username and password file is generated in accordance with the present invention. Beginning at step 202, the network authentication protocol used for secure data communications on the computer network 104 is selected. As will be understood by those skilled in the art, the desired protocol is equally capable of being selected by the administrator via the administrative server 106, or alternatively via the network device implementing the secure communications, e.g., the multifunction peripheral device 102. As previously addressed, in accordance with one embodiment of the present invention, the secure network protocol is SNMPv3. It will be appreciated by the skilled artisan that any similar secure network management protocol is equally capable of being employed by the present invention, without departing from the scope thereof.

The administrator, via administrative device 104, the sets the username and password combinations for users on the computer network 102 at step 204. It will be understood by those skilled in the art that the passwords and usernames are capable of being any alphanumeric combination of characters unique for each user on the network 102. The administrator then sets the read/write privileges corresponding to each user at step 206. The skilled artisan will appreciate that the read/write privileges suitably provide the server 106 or other shared network device, with the level of access to be granted to each user. Following assignment of user rights and privileges, the administrative device 104 generates an identification file at step 208 containing the generated usernames and passwords with the associated privileges. At step 210, the administrator suitably selects, via any means known in the art, the desired encryption method to encrypt the identification file. As will be understood by those skilled in the art, the encryption method is any suitable method of encrypting data known in the art. The identification file is then encrypted at step 212 using the selected encryption method.

At step 214, the encrypted file is stored by the administrative device 104 in a format easily exported to the client device 108 or other client device 108 on the network 102. For example and without limitation, the encrypted file is stored in a comma separated values (.csv) format. As will be appreciated by those skilled in the art, other portable database representation formats are equally capable of being implemented without departing from the scope of the present invention. At step 216, a request is received for a username and/or password from a client device 108, such as the client device 108. The corresponding identification file, in encrypted format, is transmitted to the requesting device at step 218. It will be further understood by those skilled in the art that in the event that one or more usernames or passwords change, for example a user leaves the network, or a new device is added to the network, the administrative device 104 automatically updates the identification file and transmits the file to all client device 108s, including the server 106 and the client device 108, on the computer network 102. It will be appreciated by the skilled artisan that the foregoing identification file facilitates control of access to the secure network for the administrator, enabling the alteration of a single file which is then broadcast to all devices on the network 102 for installation. As the identification file is encrypted and only the administrator is able to alter the file, the integrity and security of each user's identification and password is maintained.

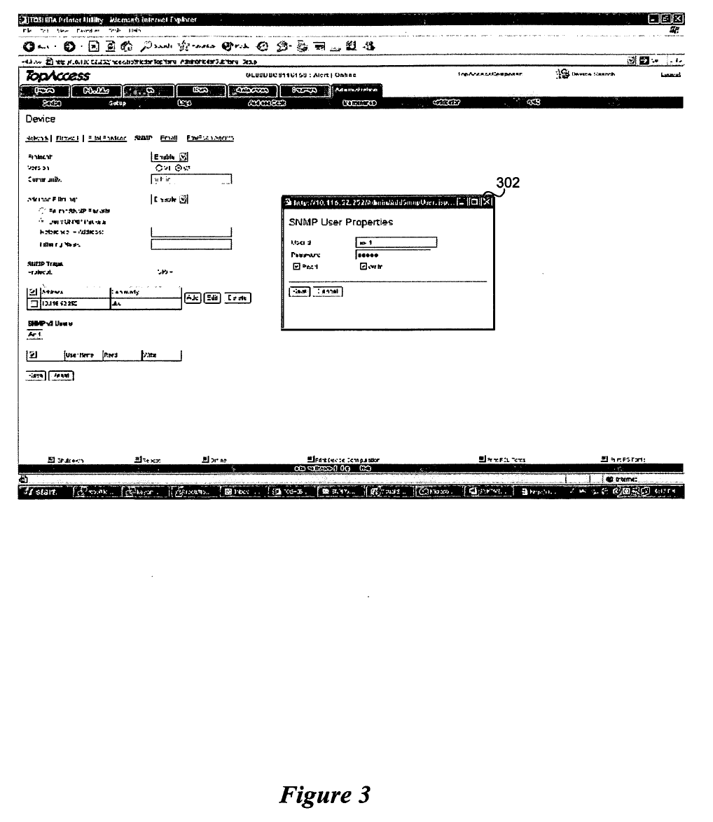

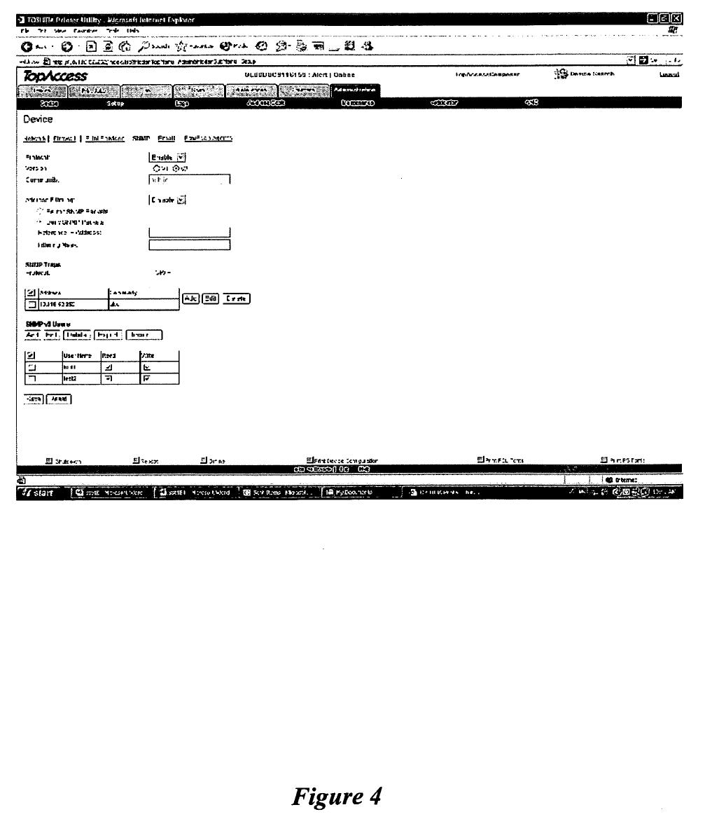

FIG. 3 illustrates a template graphical user interface 300 displayed to an administrator on the administrative device 104 to add an authorized user to the computer network 102. The interface 300 suitably includes various fields and forms which are to be completed by the administrator. As shown in FIG. 3, the administrator is able to select the type of secure network protocol to be used in authentication and communication with the new user. For example, the administrator selects the SNMP protocol, versions 1 or 3, to facilitate secure data communications between the server 106 and the client device 108. A pop-up window 302 is then displayed to the administrator, allowing the administrator to suitably set the new user's username, password, and privileges, illustrated in FIG. 3 as read and/or right. Once the administrator has set the new username, password, and associated privileges, this combination is saved in an encrypted format as explained in detail above with respect to FIG. 2. The newly created username and associated information is then ready to be exported to the client device 108 located on the network 102, as illustrated by the template screen 400 of FIG. 4. As shown in FIG. 4, the graphical user interface screen 400 allows an administrator to generate the exportable identification file containing the newly created username, password, and associated privileges. Once the exportable file has been generated, it is ready for transmission to the devices on the network 102.

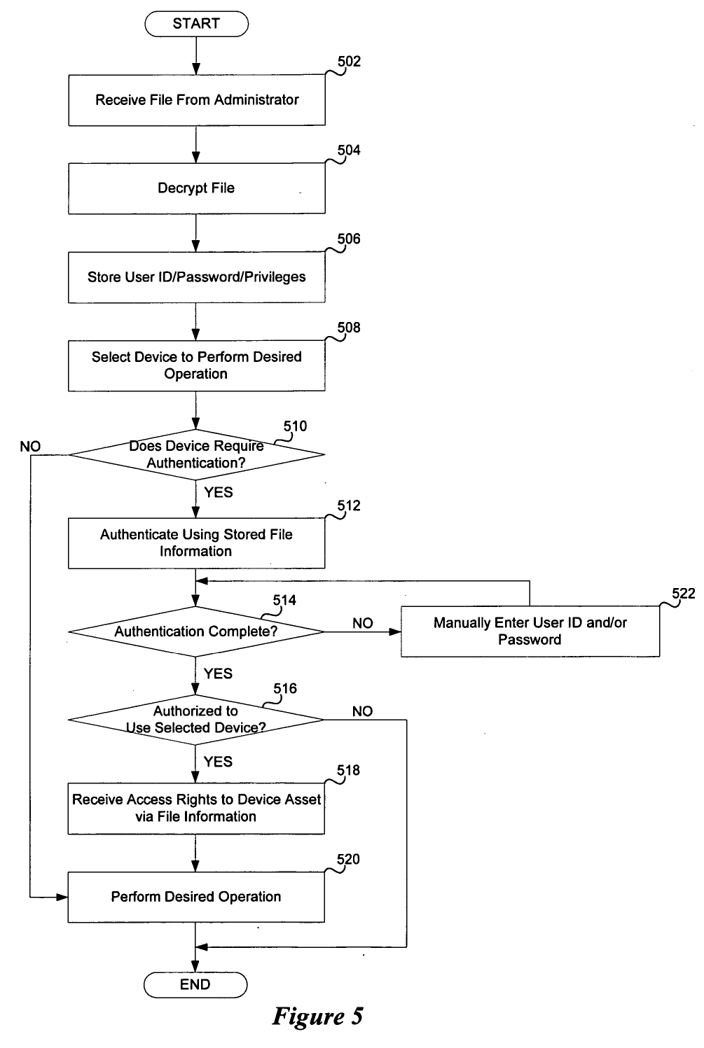

Referring now to FIG. 5, there is shown a flow chart 500 illustrating the method of client operation in accordance with the present invention. As shown in FIG. 5, the client device 108, such as the client device 108, receives the encrypted identification file from the administrative device 104 via any suitable means at step 502. Preferably, the identification file is received via the computer network 102. In one particular embodiment, the client device 108 receives the identification file when all devices on the network receive the broadcast of the identification file from the administrative device 104. As mentioned above, the client user is able to set the username/password when installing or configuring each print driver or utility via a utility application that processes the identification file suitably adapted to process the identification file. Following receipt, the identification file is decrypted by the utility application running on the client device 108 at step 504. It will be appreciated by those skilled in the art that the decryption involves only retrieving the username, password, and associated privileges corresponding to the user logged into the client device 108. While the application is capable of decryption, the user is prevented from viewing or ascertaining the decrypted contents of the identification file. Thus, should the user attempt to open the file, all that would be visible would be the encrypted contents of the identification file.

The decrypted username, password and associated privileges are then stored at step 506 in a client device 108 repository, inaccessible to the user. Preferably, an automated client process is suitably adapted to facilitate any device authentication requiring use of the username and password. It will be appreciated by those skilled in the art that the storage of the decrypted username, password and associated privileges is encrypted on the client machine by the automated client process. It will further be understood by the skilled artisan that the encryption algorithm use is capable of being the same or a different algorithm than that used by the administrative device 104. In either event, the user is still unable to view or alter the username, password and associated privileges.

At step 508, the user, via the client device 108, selects the network device, e.g., server 106, to perform a desired operation. As will be understood in the art, the operation is any processing, imaging, or other computer-based application, known in the art, including, without limitation, scanning, printing, rendering, facsimile, copying, storing, converting, and the like. The skilled artisan will appreciate that the server 106 is suitably adapted to perform a variety of applications, accessible by the client device 108 via the computer network 102. Following the selection of the desired device, a determination is made at step 510 whether the selected device requires authentication from the requesting client device 108. When no authentication is required, flow proceeds to step 520, wherein the selected device performs the desired operation.

When it is determined that the selected device requires authentication of the user associated with the requesting client device 108, flow proceeds to step 512, wherein authentication is initiated by the client device 108 using the stored information identification file. It will be understood by those skilled in the art that the present invention enables the rapid authentication of the requesting device by bypassing the typical username and password prompts. At step 514, a determination is made whether or not authentication has been completed. When authentication fails using the automated client process, the user is prompted at step 522 to manually enter the username and password. Flow then proceeds back to the determining step 514 to ascertain whether or not authentication has been successful.

Following successful authentication, a determination is made at step 516 whether or not the user is authorized to access the selected device. It will be appreciated by those skilled in the art that the determination for authorization is suitably based upon the rights and privileges contained in the identification file as mentioned above. Such rights and privileges advantageously include which type of operations the user is authorized to request. Upon a determination that the user is authorized to access the selected device, based upon the identification file information, the client device 108 receives rights commensurate with the privileges in the identification file at step 518. The selected device then performs the desired operation at step 520.

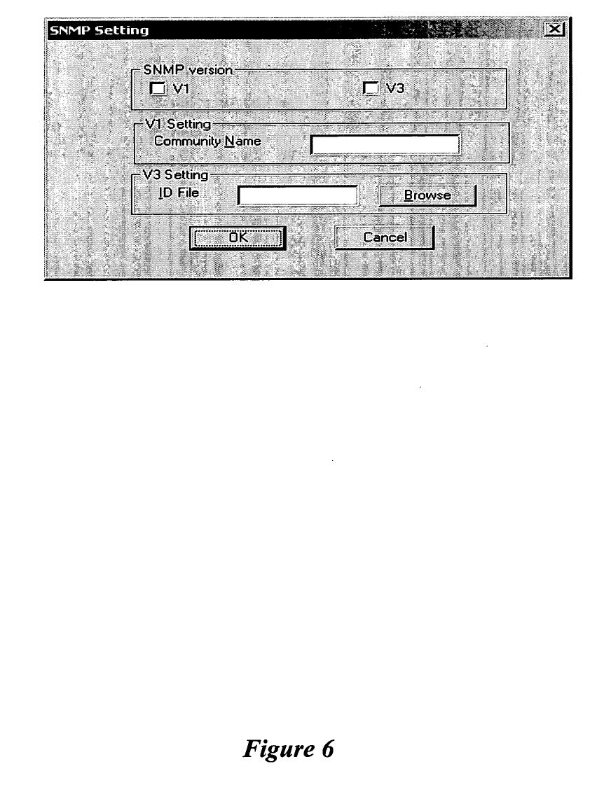

Turning now to FIG. 6, there is shown a template window 600 illustrating a pop-up window displayed to a user by the automated client process running on the client device 108. As mentioned above, instead of requiring the user to repeatedly enter his username and password to establish secure communications with the server 106, the automated client process displays the window 600 upon receipt by the client device 108 of the identification file. The user then selects the filename associated with the identification file containing the encrypted username, password and associated privileges. After completion of the required fields, the information is saved by the automated client process on the client device 108 and each time authentication is required by the server 106, the automated client process automatically communicates the appropriate information to the server 106 without requiring further input from the user.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A network device administration system comprising:
a file generator adapted for generating an encrypted electronic file, the encrypted electronic file including data representative of a plurality of usernames and a corresponding plurality of passwords;
means adapted for communicating the encrypted electronic file to each of a plurality of networked data devices;
means adapted for receiving connection data representative of an acceptance via a workstation of an entry of a username and password relative to data in the encrypted electronic file; and
means adapted for selectively enabling a selected, shared networked data device upon receipt of the connection data.

2. The network device administration system of claim 1 wherein the file generator further comprises means adapted for generating the encrypted electronic file inclusive of permission data representative of at least one permission associated with each of the plurality of usernames and passwords.

3. The network device administration system of claim 2 wherein the means for selectively enabling includes means adapted for selectively enabling at least one of the group consisting of access to the networked data device and usage of features associated with the networked data device in accordance with permission data.

4. The network device administration system of claim 3 further comprising at least one networked data device inclusive of means adapted for receiving the encrypted electronic file so as to be associated with a device driver corresponding to the shared networked data device.

5. The network device administration system of claim 4, further comprising means adapted for storing the received electronic file in an encrypted format.

6. The network device administration system of claim 1, further means adapted for storing the encrypted electronic file in an exportable file format.

7. A method for network device administration, comprising the steps of:
generating an encrypted electronic file, the encrypted electronic file including data representative of a plurality of usernames and a corresponding plurality of passwords;
communicating the encrypted electronic file to each of a plurality of networked data devices;
receiving connection data representative of an acceptance via a workstation of an entry of a username and password relative to data in the encrypted electronic file; and
selectively enabling a selected, shared networked data device upon receipt of the connection data.

8. The method for network device administration of claim 7, further comprising the step of generating the encrypted electronic file inclusive of permission data representative of at least one permission associated with each of the plurality of usernames and passwords.

9. The method for network device administration system of claim 8, further comprising the step of selectively enabling at least one of the group consisting of access to the networked data device and usage of features associated with the networked data device in accordance with permission data.

10. The method for network device administration of claim 9 further comprising the step of receiving the electronic file by at least one network device so as to be associated with a device driver corresponding to the shared network device.

11. The method for network device administration of claim 10, further comprising the step of storing the received electronic file in an encrypted format.

12. The method for network device administration of claim 10, wherein the encrypted electronic file is generated via a file generator.

13. The method for network device administration of claim 7, further comprising the step of storing the encrypted electronic file in an exportable format.

14. A computer-implemented method for network device administration, comprising the steps of:
generating an encrypted electronic file, the encrypted electronic file including data representative of a plurality of usernames and a corresponding plurality of passwords;
communicating the encrypted electronic file to each of a plurality of networked data devices;
receiving connection data representative of an acceptance via a workstation of an entry of a username and password relative to data in the encrypted electronic file; and
selectively enabling a selected, shared networked data device upon receipt of the connection data.

15. The method for network device administration of claim 14, further comprising the step of generating the encrypted electronic file inclusive of permission data representative of at least one permission associated with each of the plurality of usernames and passwords.

16. The method for network device administration system of claim 15, further comprising the step of selectively enabling at least one of the group consisting of access to the networked data device and usage of features associated with the networked data device in accordance with permission data.

17. The method for network device administration of claim 16 further comprising the step of receiving the electronic file by at least one network device so as to be associated with a device driver corresponding to the shared network device.

18. The method for network device administration of claim 17, further comprising the step of storing the received electronic file in an encrypted format.

19. The method for network device administration of claim 17, wherein the encrypted electronic file is generated via a file generator.

20. The method for network device administration of claim 14, further comprising the step of storing the encrypted electronic file in an exportable format.
